(19) United States
(12) Patent Application Publication
(10) Pub. No.: US 2026/0054478 A1
(43) Pub. Date: Feb. 26, 2026

(54) LIQUID EJECTION APPARATUS AND CONTROL METHOD

(71) Applicant: CANON KABUSHIKI KAISHA, Tokyo (JP)

(72) Inventors: YUJI NUKUI, Kanagawa (JP); FUMI TANAKA, Kanagawa (JP); KEIJI TOMIZAWA, Kanagawa (JP); SHUZO IWANAGA, Kanagawa (JP); KOICHI ISHIDA, Tokyo (JP); YUZURU ISHIDA, Kanagawa (JP); YUGO YAMAMOTO, Kanagawa (JP)

(21) Appl. No.: 19/289,454

(22) Filed: Aug. 4, 2025

(30) Foreign Application Priority Data
Aug. 21, 2024 (JP) 2024-139890

(51) Int. Cl. B41J 2/045; B41J 2/14; B41J 2/175; B41J 29/17

(52) U.S. Cl. CPC B41J 2/04513; B41J 2/04573; B41J 2/0458; B41J 2/14072; B41J 2/14112; B41J 2/17546; B41J 29/17

(57) ABSTRACT

Provided is a liquid ejection apparatus capable of executing a kogation removal process at appropriate timing, thereby stably ejecting a liquid without shortening the lifespan of a head. For this purpose, the timing to execute the kogation removal operation of dissolving a metal in a protective layer through an electrochemical reaction with the liquid is determined based on information on an ejection characteristic of the liquid.

### BACKGROUND

### Field of the Technology

The present disclosure relates to a liquid ejection apparatus and a control method.

Some liquid ejection apparatuses configured to perform printing by ejecting liquids such as inks employ, as a method of generating energy for liquid ejection, a method of heating the inks with electrothermal transducer elements each including a heating resistor (hereinafter also referred to as “heaters”), thereby generating bubbles and ejecting the inks. In the case of the method of ejecting the inks with heating by the heaters, the heaters heat the inks, thereby generating kogation of the inks on the surfaces of the heaters, which may result in a change in the ejection velocity. In a case where the liquid ejection apparatus is a printing apparatus, a change in the ejection velocity in some of the heaters may cause misregistration of the landing positions, thereby resulting in the occurrence of defects such as thinning of lines, disturbance of characters, and changes in color tones, and eventually deterioration of print quality.

Japanese Patent Laid-Open No. 2008-105364 discloses a technique in which a protective layer to act as an electrode for causing an electrochemical reaction with an ink is disposed in a heating portion, the technique including causing the electrochemical reaction with the ink at timing when the number of printed dots exceeds a threshold, thereby dissolving the surface layer of the protective layer to remove kogation on the heating portion.

However, a degree of kogation adhesion varies depending on factors such as an ink type, an ink production lot, material lots, and the average particle size of a pigment in a case where the ink is a pigment ink. Therefore, in the case of using some types of inks, the operation of executing the kogation removal at fixed timing as in Japanese Patent Laid-Open No. 2008-105364 may dissolve the protective layer in a state having no kogation adhesion and resultantly shorten the lifespans of the heaters.

### SUMMARY OF THE INVENTION

Therefore, the present disclosure provides a liquid ejection apparatus capable of executing a kogation removal process at appropriate timing, and thereby stably ejecting a liquid without shortening the lifespan of a head.

To this end, a liquid ejection apparatus in the present disclosure is a liquid ejection apparatus including: an ejection unit including a heating resistor configured to generate heat with power supply, thereby generating energy for ejecting a liquid, a protective portion configured to cover and protect the heating resistor, and an electrode portion capable of electrically connecting with the protective portion via the liquid; and a control unit configured to control a kogation removal operation of removing kogation by applying a voltage between the protective portion and the electrode portion, and thereby dissolving the protective portion into the liquid. Based on information on an ejection characteristic of a liquid, the control unit determines timing to execute the kogation removal operation in the ejection unit configured to eject the liquid.

According to the present disclosure, it is possible to provide a technique for preventing the deterioration of print quality and the shortening of the lifespans of electrothermal transducer elements.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a schematic structure of a liquid ejection apparatus;

FIG. 2 is a block diagram illustrating a configuration of a printing apparatus;

FIG. 3 is a schematic diagram illustrating a first circulation path as one mode of a circulation path;

FIG. 4 is a schematic diagram illustrating a second circulation path;

FIGS. 5A and 5B are perspective views of a liquid ejection head;

FIG. 6 is an exploded perspective view of components or units constituting the liquid ejection head;

FIGS. 7A to 7F are views illustrating front surfaces and back surfaces of first to third channel members;

FIG. 8 is a see-through view seen from the surface of the first channel member on which ejection modules are mounted;

FIG. 9 is a view illustrating a cross section taken along a line IX-IX in FIG. 8;

FIGS. 10A and 10B are perspective views illustrating an ejection module;

FIGS. 11A to 11C are plan views of a print element board;

FIG. 12 is a perspective view illustrating a cross section of a print element board and a lid member;

FIG. 13 is a partially enlarged plan view illustrating adjacent portions of print element boards;

FIGS. 14A and 14B are diagrams illustrating an area near a heating portion in a print element board;

FIGS. 15A and 15B are graphs each presenting a relationship between an ejection velocity and the number of ejections;

FIG. 16 is a diagram illustrating communication between liquid ejection heads, ink cartridges, and a main body;

FIG. 17 is a diagram presenting an example of a table for calculating an interval of kogation removal;

FIG. 18 is a flowchart presenting an example of a sequence of a printing process and a kogation removal process;

FIG. 19 is a flowchart presenting printing processing;

FIG. 20 is a flowchart presenting printing processing; and

FIG. 21 is a diagram illustrating an example of an ejection velocity detection pattern.

### DESCRIPTION OF THE EMBODIMENTS

Hereinafter, a first embodiment of the present disclosure will be described in reference to the drawings.

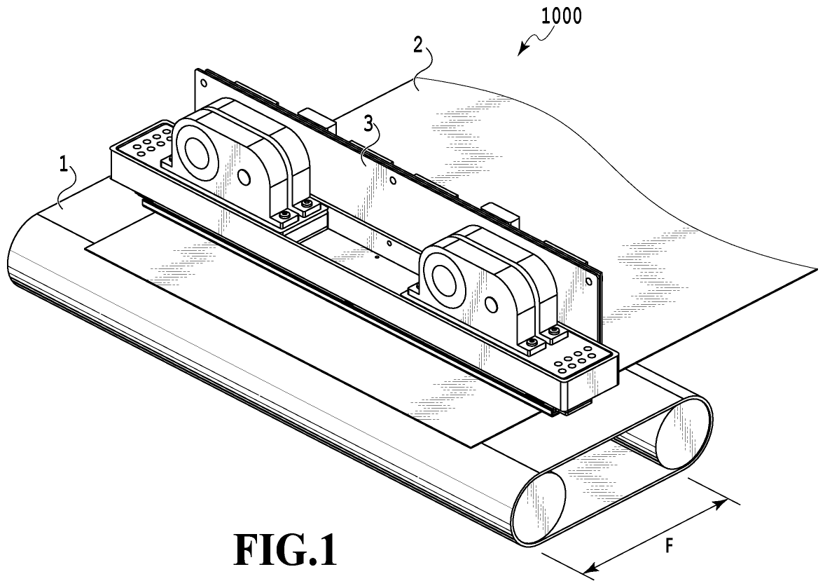

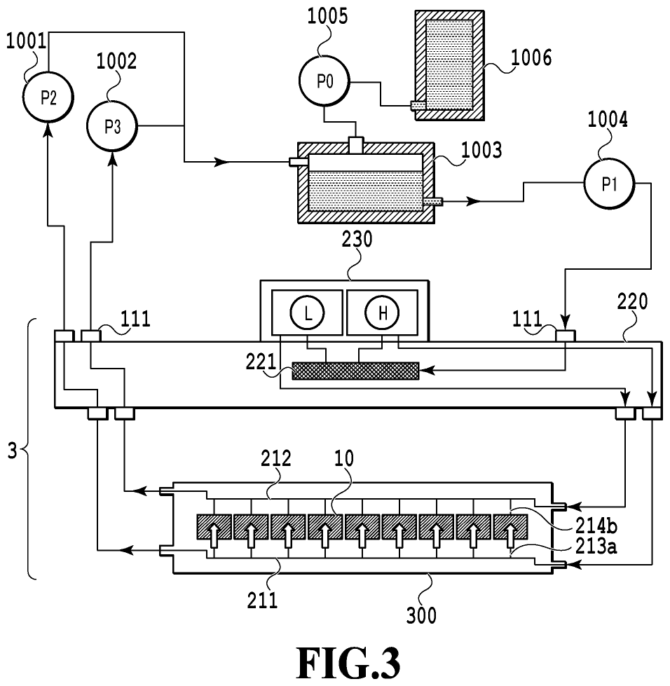

FIG. 1 is a view illustrating a schematic structure of a liquid ejection apparatus (also referred to as a printing apparatus) 1000 according to the present embodiment. The printing apparatus 1000 is a line-type printing apparatus including a conveyor unit 1 configured to convey a print medium 2 and a line-type liquid ejection head 3 arranged substantially orthogonal to a print medium conveyance direction. The line-type printing apparatus performs continuous printing by one pass while continuously or intermittently conveying multiple print media 2. The print medium 2 is not limited to a cut sheet, but may be continuous roll paper. The liquid ejection head 3 is capable of performing full-color printing with liquid cyan, magenta, yellow, and black (CMYK) inks. One liquid ejection head 3 may support one color or multiple colors. The liquid ejection head 3 is fluidly connected to a liquid supply system constituting a supply path for supplying each of the inks to the liquid ejection head 3, an ink cartridge 1006 serving as a main tank, and a buffer tank 1003 (see FIG. 3), as described later. Furthermore, a power controller configured to transmit power and ejection control signals to the liquid ejection head 3 is electrically connected to the liquid ejection head 3. A liquid path and an electric signal path in the liquid ejection head 3 are described later. The printing apparatus 1000 circulates the inks via the liquid ejection head 3.

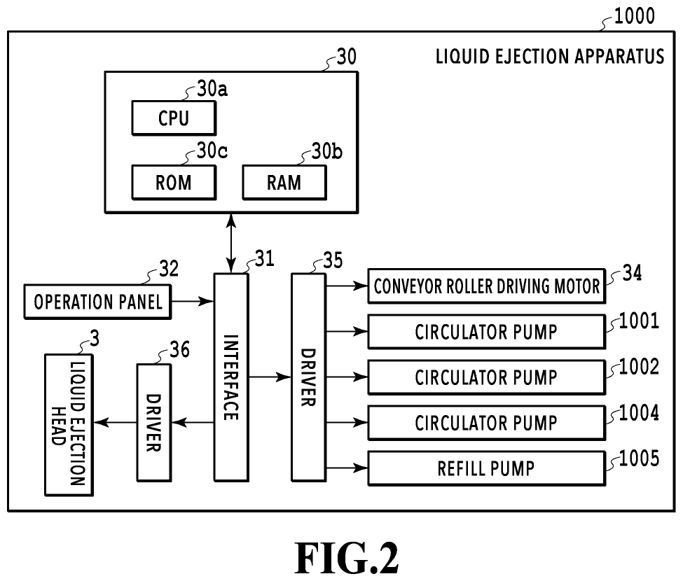

FIG. 2 is a block diagram illustrating a configuration of the printing apparatus 1000. The printing apparatus 1000 includes a control unit 30 including a CPU 30a such as a microprocessor and a RAM 30b which is used as a work area of the CPU 30a and which, for example, stores various kinds of data such as print data and registration adjustment values. The control unit 30 includes a ROM 30c which stores a control program of the CPU 30a and various kinds of data. Moreover, the printing apparatus 1000 includes an interface 31, an operation panel 32, and drivers 35 and 36. The driver 35 drives and controls a conveyor roller driving motor 34 and circulator pumps 1001, 1002, and 1004 and a refill pump 1005, which are provided to an ink supply channel. The driver 36 drives the liquid ejection head 3.

Print data received by the printing apparatus 1000 is stored in the RAM 30b of the control unit 30. According to the print data stored in the RAM 30b, the control unit 30 outputs ON/OFF signals for driving the motor 34 to the driver 35 and outputs ejection signals and so on to the driver 36, thereby forming an image on a print medium. Moreover, according to a control sequence to be described later, the control unit 30 outputs a signal for driving the circulator pump 1002 to the driver 35, thereby controlling the circulator pump 1002.

FIG. 3 is a schematic diagram illustrating a first circulation path as one mode of a circulation path applied to the printing apparatus according to the present embodiment. As illustrated in FIG. 3, the liquid ejection head 3 is fluidly connected to two first circulator pumps 1001 (high pressure side) and 1002 (low pressure side), the buffer tank 1003, and so on. Although FIG. 3 only illustrates the path in which only one color of ink among the CMYK inks circulates for simplification of description, circulation paths for the four colors are actually provided in the liquid ejection head 3 and a printing apparatus main body.

The printing apparatus 100 includes the buffer tank 1003 as a subtank to which an ink cartridge 1006 containing the ink is attachable and which is connected to the ink cartridge 1006. The buffer tank 1003 includes an air communication hole (not illustrated) through which the inside and the outside of the buffer tank 1003 communicate with each other and is capable of discharging air bubbles in the ink to the outside. The buffer tank 1003 is also connected to the refill pump 1005. As the ink is consumed by the liquid ejection head 3, the refill pump 1005 transfers the consumed volume of the ink from the ink cartridge 1006 to the buffer tank 1003. For example, the ink is consumed by the liquid ejection head 3 in a case where the ink is ejected (discharged) from ejection orifices of the liquid ejection head for printing with ink ejection, suction recovery, or the like The two first circulator pumps 1001 and 1002 have the role of sucking the ink from liquid connection portions 111 of the liquid ejection head 3 and delivering the ink to the buffer tank 1003. The first circulator pumps 1001 and 1002 are preferably positive displacement pumps each having a capacity of delivering a fixed volume of liquid. Specifically, the first circulator pumps 1001 and 1002 may be tube pumps, gear pumps, diaphragm pumps, syringe pumps, and so on. Instead, for example, a pump equipped with a general constant flow valve or relief valve installed at the pump outlet to ensure a constant flow rate may be used. During driving of the liquid ejection head 3, the first circulator pump (high pressure side) 1001 and the first circulator pump (low pressure side) 1002 cause a certain fixed volume of the ink to flow in each of a common supply channel 211 and a common collection channel 212. This flow rate is preferably set to equal to or higher than such a flow rate that the temperature variation among print element boards 10 in the liquid ejection head 3 will not affect the quality of printed images. However, in the case where too high a flow rate is set, a negative pressure variation among the print element boards 10 becomes too large due to pressure drops in channels inside a liquid ejection unit 300, resulting in uneven density in an image. For this reason, it is preferable to set the flow rate with the temperature variation and the negative pressure variation among the print element boards 10 taken into consideration.

A negative pressure control unit 230 is provided in the middle of a path connecting the second circulator pump 1004 and the liquid ejection unit 300. The negative pressure control unit 230 has a function to operate to maintain the pressure on the side downstream of the negative pressure control unit 230 (in other words, on the liquid ejection unit 300 side) at a preset constant pressure even in a case where the flow rate in a circulation system varies due to a change in the duty for printing. Two pressure regulation mechanisms constituting the negative pressure control unit 230 may be any mechanisms capable of controlling the pressure on the side downstream of them within a certain fluctuation range centered on a desired set pressure. As an example, a mechanism similar to a so-called “pressure reducing regulator” may be employed. In the case where pressure reducing regulators are used, it is preferable that the second circulator pump 1004 apply a pressure to the side upstream of the negative pressure control unit 230 via a liquid supply unit 220. Since this structure can reduce an influence of a water head pressure of the buffer tank 1003 on the liquid ejection head 3, the degree of freedom in the layout of the buffer tank 1003 in the printing apparatus 1000 can be increased. The second circulator pump 1004 may be any pump having a pump head pressure equal to or higher than a certain pressure under condition within a range of an ink circulation flow rate to be used during driving of the liquid ejection head 3, and may be a turbo pump, a positive displacement pump, or the like. Specifically, a diaphragm pump or the like may be used. Instead of the second circulator pump 1004, for example, a water head tank positioned with a certain water head difference from the negative pressure control unit 230 may be used.

As illustrated in FIG. 3, the negative pressure control unit 230 includes the two pressure regulation mechanisms which are set with different control pressures. Of the two pressure regulation mechanisms, the pressure regulation mechanism set with a relatively high pressure (denoted by H in FIG. 3) is connected to the common supply channel 211 of the liquid ejection unit 300 via the liquid supply unit 220. Meanwhile, the pressure regulation mechanism set with a relatively low pressure (denoted by L in FIG. 3) is connected to the common collection channel 212 via the liquid supply unit 220.

The liquid ejection unit 300 is provided with the common supply channel 211 and the common collection channel 212 as well as dedicated supply channels 213a and dedicated collection channels 214b which communicate with the respective print element boards 10. The dedicated supply channels 213a communicate with the common supply channel 211, while the dedicated collection channels 214b communicate with the common collection channel 212. This structure generates flows (arrows in FIG. 3) in which portions of the ink flow from the common supply channel 211 to the common collection channel 212 through internal channels of the print element boards 10. This is because the structure in which the pressure regulation mechanism H is connected to the common supply channel 211 and the pressure regulation mechanism L is connected to the common collection channel 212 generates a differential pressure between these two common channels.

In this way, in the liquid ejection unit 300, flows are generated such that the ink passes through the insides of the common supply channel 211 and the common collection channel 212 and portions of the ink pass through the insides of the print element boards 10. Thus, the heat generated in each of the print element boards 10 can be released to the outside of the print element board 10 with the flows passing through the common supply channel 211 and the common collection channel 212. In addition, this structure makes it possible to generate flows of the ink also in the ejection orifices and the pressure chambers which are not engaged in printing during printing by the liquid ejection head 3, thereby preventing the thickening of the ink in those areas. Moreover, this structure can also discharge the thickened ink and foreign substances contained in the ink to the common collection channel 212. Therefore, the liquid ejection head 3 in the present embodiment is capable of achieving high-speed and high-quality printing.

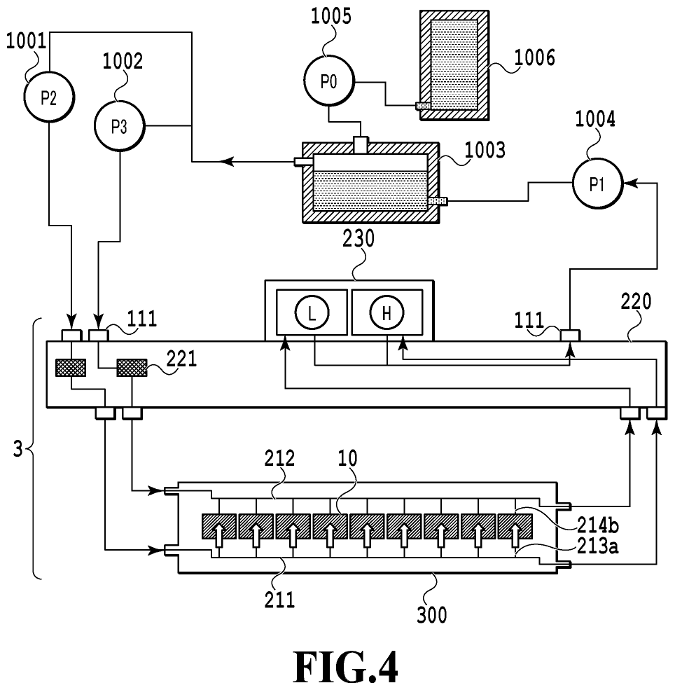

FIG. 4 is a schematic diagram illustrating a second circulation path different from the aforementioned first circulation path among circulation paths applied to the printing apparatus 1000 according to the present embodiment. Main differences from the first circulation path are as follows.

First, each of two pressure regulation mechanisms constituting the negative pressure control unit 230 has a mechanism capable of controlling the pressure on the side upstream of the negative pressure control unit 230 within a certain fluctuation range centered on a desired set pressure (a mechanical component to act in the same way as a so-called “back pressure regulator”). Second, the second circulator pump 1004 acts as a negative pressure source to reduce the pressure on the side downstream of the negative pressure control unit 230. Third, the first circulator pump (high pressure side) 1001 and the first circulator pump (low pressure side) 1002 are arranged upstream of the liquid ejection head 3, while the negative pressure control unit 230 is arranged downstream of the liquid ejection head 3.

In the second circulation path, the negative pressure control unit 230 operates during printing by the liquid ejection head 3 such that pressure fluctuations on the side upstream of the negative pressure control unit 230 (in other words, the liquid ejection unit 300 side) may be kept within a certain range even if the flow rate varies due to a change in the duty for printing. The pressure fluctuations are kept, for example, within a certain range centered on a preset pressure. As illustrated in FIG. 4, it is preferable that the second circulator pump 1004 pressurize the side downstream of the negative pressure control unit 230 via the liquid supply unit 220. Since this structure can reduce an influence of a water head pressure of the buffer tank 1003 on the liquid ejection head 3, the degree of freedom in the layout of the buffer tank 1003 in the printing apparatus 1000 can be increased. Instead of the second circulator pump 1004, for example, a water head tank positioned with a certain water head difference from the negative pressure control unit 230 may be used.

As similar to the first circulation path, the negative pressure control unit 230 illustrated in FIG. 4 includes the two pressure regulation mechanisms which are set with different control pressures. Of the two pressure regulation mechanisms, the pressure regulation mechanism set with a relatively high pressure (denoted by H in FIG. 4) is connected to the common supply channel 211 of the liquid ejection unit 300 via the liquid supply unit 220. Meanwhile, the pressure regulation mechanism set with a relatively low pressure (denoted by L in FIG. 4) is connected to the common collection channel 212 via the liquid supply unit 220.

With the two pressure regulation mechanisms, the pressure in the common supply channel 211 is made higher than the pressure in the common collection channel 212. This structure generates the ink flows from the common supply channel 211 to the common collection channel 212 through the dedicated supply channels 213 and the internal channels of the print element boards 10 (arrows in FIG. 4). Although the second circulation path thus generates, in the liquid ejection unit 300, the same ink flows as in the first circulation path, the second circulation path has two advantages over the first circulation path.

The first advantage is that since the negative pressure control unit 230 is arranged downstream of the liquid ejection head 3 in the second circulation path, there is less concern that dust or foreign substances generated in the negative pressure control unit 230 will flow into the liquid ejection head 3. The second advantage is that the maximum value of the necessary flow volume to be supplied from the buffer tank 1003 to the liquid ejection head 3 in the second circulation path can be smaller than in the first circulation path, for the following reason. Here, the total flow volume in the common supply channel 211 and the common collection channel 212 in the ink circulation during standby for printing is defined as A. The value A is defined as a minimum flow volume necessary to control temperature variations in the liquid ejection unit 300 within a desired range in the case where the temperature regulation in the liquid ejection head 3 is performed during standby for printing. In addition, the ejection flow volume required to eject the ink from all the ejection orifices of the liquid ejection unit 300 (full ejection) is defined as F. In the case of the first circulation path (see FIG. 3), since the total value of the set flow volumes of the first circulator pump (high pressure side) 1001 and the first circulator pump (low pressure side) 1002 is A, the maximum value of the necessary liquid supply volume to the liquid ejection head 3 for the full ejection is A+F.

On the other hand, in the case of the second circulation path (see FIG. 4), the necessary liquid supply volume to the liquid ejection head 3 during standby for printing is the flow volume A. Then, the necessary liquid supply volume to the liquid ejection head 3 for the full ejection is the flow volume F. Thus, in the case of the second circulation path, the total value of the set flow volumes of the first circulator pump (high pressure side) 1001 and the first circulator pump (low pressure side) 1002, that is, the maximum value of the necessary liquid supply volume is a larger value of A and F. For this reason, as long as the liquid ejection unit 300 with the same structure is used, the maximum value (A or F) of the necessary liquid supply volume in the second circulation path is always smaller than the maximum value (A+F) of the necessary liquid supply volume in the first circulation path. Accordingly, in the case of the second circulation path, the degree of freedom of an applicable circulator pump is increased. Thus, there is an advantage in that the cost of the printing apparatus main body can be reduced because a simple low-cost circulator pump can be used and the load on a cooler (not illustrated) installed in a main body path can be reduced. This advantage is significant for a line head having a relatively large value A or F and is more significant as the longitudinal length of a line head becomes longer.

However, the first circulation path also has an advantage over the second circulation path. Specifically, in the second circulation path, the flow volume in the liquid ejection unit 300 during standby for printing is at its maximum, so that the lower the duty for printing, the higher the negative pressure applied to each ejection orifice. For this reason, particularly in a case where the channel widths (lengths in the direction perpendicular to the ink flow direction) of the common supply channel 211 and the common collection channel 212 are reduced and the head width (length in the short direction of the liquid ejection head) is reduced, a high negative pressure is applied to the ejection orifices for low-duty images in which unevenness is more noticeable. The application of such a high negative pressure may increase the influence of satellite droplets. On the other hand, in the case of the first circulation path, a high negative pressure is applied to the ejection orifices at timing of forming high-duty images, which is advantageous in that satellites, even if occur, are less noticeable and have little influence on the printed images. From the two circulation paths, a preferable circulation path may be selected in light of the specifications of the liquid ejection head and the printing apparatus main body (the ejection flow volume F, the minimum circulation flow volume A, and the channel flow resistance in the head).

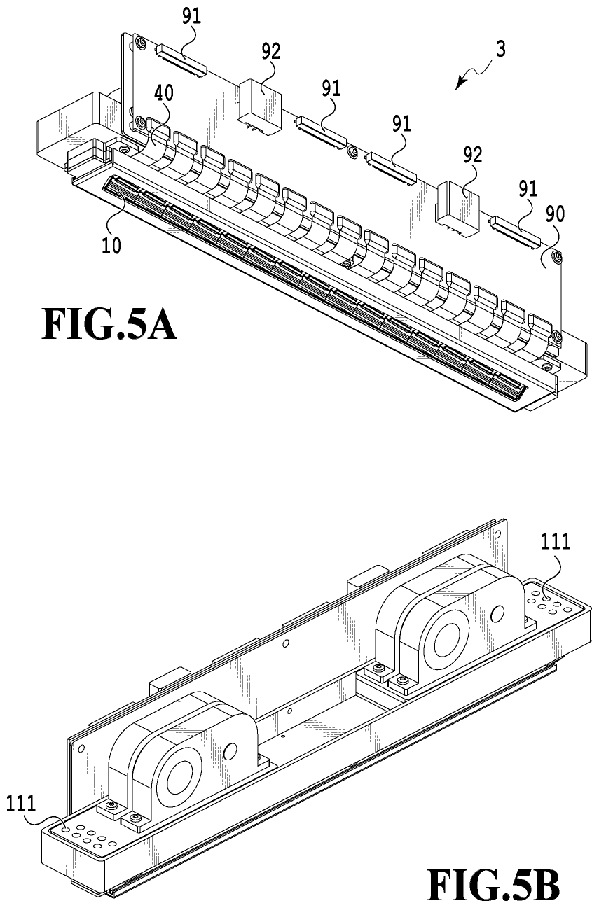

FIGS. 5A and 5B are perspective views of the liquid ejection head 3. The following description of FIGS. 5A to 13 is given of a mode in which one liquid ejection head ejects four colors of inks. As illustrated in FIG. 5A, the liquid ejection head 3 includes the print element boards 10 as well as signal input terminals 91 and power supply terminals 92 which are connected to the print element boards 10 via flexible wiring boards 40 and an electric wiring board 90. The signal input terminals 91 and the power supply terminals 92 are electrically connected to the control unit 30 of the printing apparatus 1000. Ejection drive signals are supplied to the print element boards 10 via the signal input terminals 91 and power necessary for ejection is supplied to the print element boards 10 via the power supply terminals 92.

The wiring lines are consolidated by using electric circuits in the electric wiring board 90, so that the number of the signal input terminals 91 and the number of the power supply terminals 92 can be made smaller than the number of the print element boards 10. This reduces the number of electrical connection points which need to be connected in mounting the liquid ejection head 3 onto the printing apparatus 1000 or to be disconnected in replacing the liquid ejection head 3. As illustrated in FIG. 5B, the liquid connection portions 111 provided on both end sides of the liquid ejection head 3 are connected to the liquid supply system of the printing apparatus 1000. Through these portions, the inks are supplied from the supply system of the printing apparatus 1000 to the liquid ejection head 3 and the inks after passing through the liquid ejection head 3 are returned to the supply system of the printing apparatus 1000. In this way, these colors of inks can be circulated via paths of the printing apparatus 1000 and paths of the liquid ejection head 3.

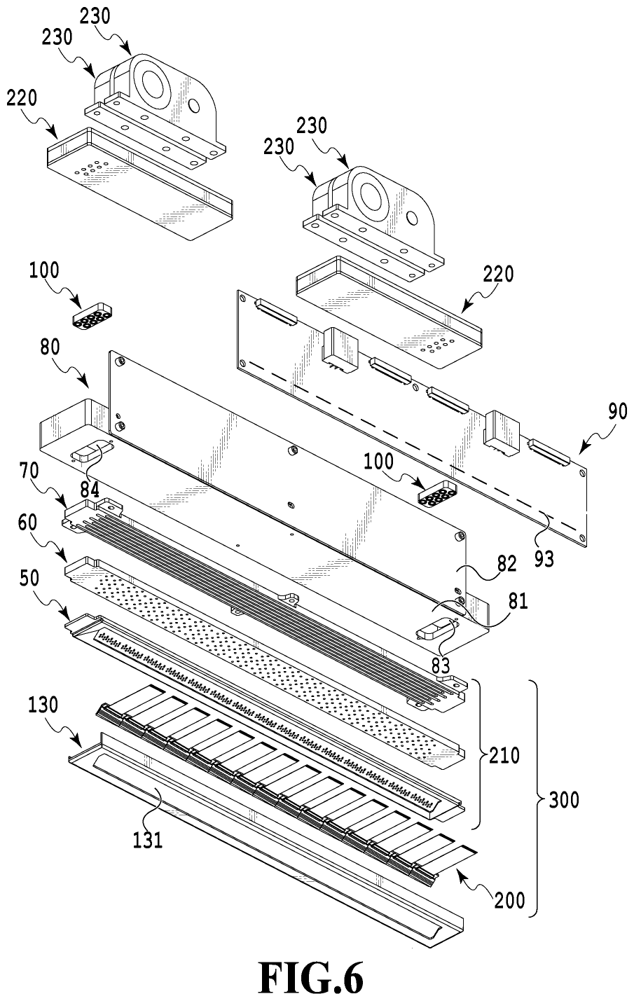

FIG. 6 is an exploded perspective view of components or units constituting the liquid ejection head 3. The liquid ejection unit 300, the liquid supply units 220, and the electric wiring board 90 are attached to a casing 80. The liquid supply units 220 are provided with the liquid connection portions 111 (see FIGS. 3 to 5). Inside the liquid supply units 220, filters 221 for the respective colors (see FIGS. 3 and 4) are provided which communicate with openings of the liquid connection portion 111 in order to remove foreign substances from the inks to be supplied. Each of the two liquid supply units 220 is provided with the filters 221 for two colors. The inks after passing through the filters 221 are supplied to the negative pressure control units 230 for the respective colors arranged on the liquid supply units 220.

The negative pressure control unit 230 is a unit for each color including a pressure regulator valve. By actions of valves, spring members, and so on provided inside the negative pressure control unit 230, the negative pressure control unit 230 significantly attenuates a pressure drop change that occurs with a fluctuation of the ink flow rate in the supply system of the printing apparatus 1000 (the supply system upstream of the liquid ejection head 3). For this reason, the negative pressure control unit 230 is capable of stabilizing a negative pressure change within a certain range on the side downstream of the negative pressure control unit 230 (on the liquid ejection unit 300 side). The negative pressure control unit 230 for each color internally includes the two pressure regulator valves for the above color as described with reference to FIG. 3. These pressure regulator valves are set with different control pressures. The valve on the high pressure side communicates with the common supply channel 211 and the valve on the low pressure side communicates with the common collection channel 212 in the liquid ejection unit 300 via the liquid supply unit 220.

The casing 80 includes a liquid ejection unit support portion 81 and an electric wiring board support portion 82, and ensures the stiffness of the liquid ejection head 3 while supporting the liquid ejection unit 300 and the electric wiring board 90. The electric wiring board support portion 82 is for supporting the electric wiring board 90 and is fixed to the liquid ejection unit support portion 81 with screws. The liquid ejection unit support portion 81 has a role of ensuring the accuracy of the relative positions of the multiple print element boards 10 by correcting warping and deformation of the liquid ejection unit 300, thereby suppressing streaks and unevenness on printed products. For this purpose the liquid ejection unit support portion 81 preferably has sufficient stiffness, and a preferable material therefor is a metal material such as SUS or aluminum or ceramic such as alumina. The liquid ejection unit support portion 81 is provided with openings 83 and 84 into which joint rubbers 100 are inserted. The inks supplied from liquid supply units 220 are guided via the joint rubbers 100 to a third channel member 70 included in the liquid ejection unit 300.

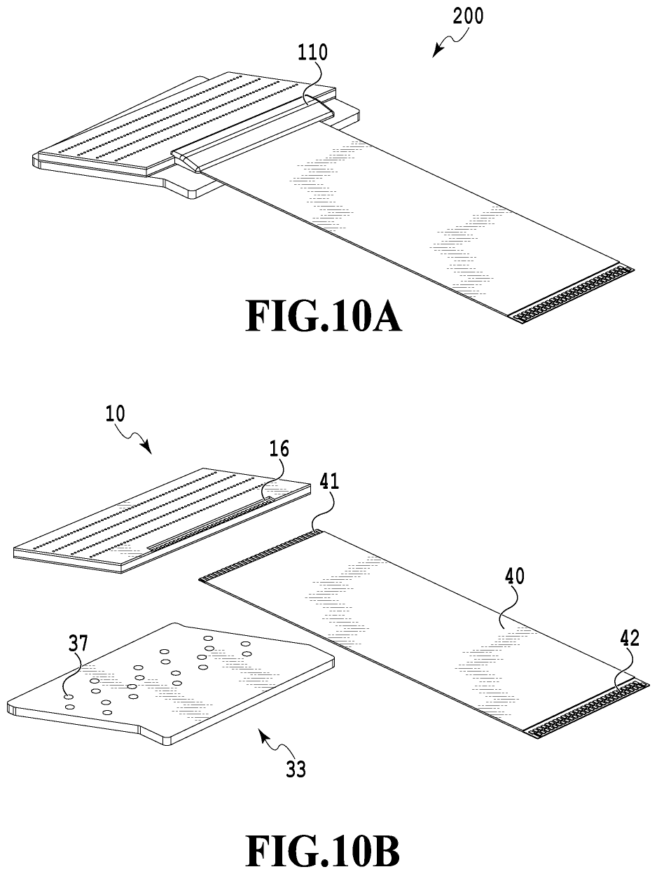

The liquid ejection unit 300 includes multiple ejection modules 200 and a channel member 210. A cover member 130 is attached to a surface of the liquid ejection unit 300 on a print medium side. The cover member 130 is a member having a frame-shaped surface provided with a long opening 131, and the print element boards 10 and seal members 110 (see FIG. 10A) included in the ejection modules 200 are exposed from the opening 131. The frame portion around the opening 131 functions as a contact surface to come into contact with a capping member configured to cap the liquid ejection head 3 during standby for printing. For this purpose, it is preferable to apply an adhesive, a sealant, a filler, or the like along the periphery of the opening 131 to fill in irregularities and gaps on the ejection orifice surface of the liquid ejection unit 300 so that a closed space is formed in a state where the liquid ejection unit 300 is capped.

Next, a structure of the channel member 210 included in the liquid ejection unit 300 is described. As illustrated in FIG. 6, the channel member 210 is formed by stacking a first channel member 50, a second channel member 60, and the third channel member 70. The channel member 210 distributes the inks supplied from the liquid supply units 220 to the ejection modules 200, and also returns the inks circulating from the ejection modules 200 to the liquid supply units 220. The channel member 210 is fixed to the liquid ejection unit support portion 81 with screws, which suppresses warping or deformation of the channel member 210.

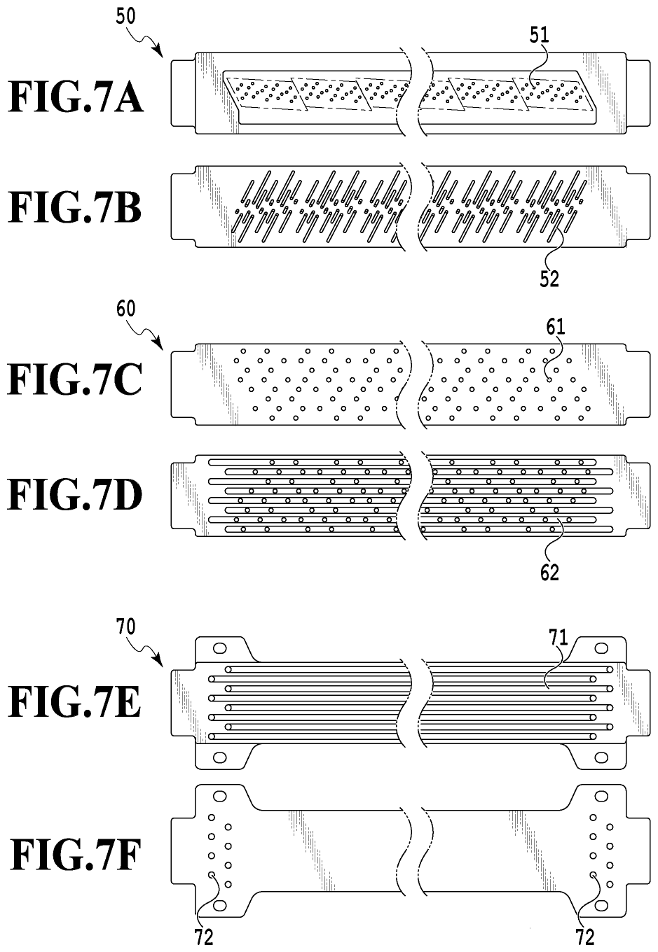

FIGS. 7A to 7F are views illustrating front surfaces and back surfaces of the first to third channel members. FIG. 7A illustrates a surface of the first channel member 50 on which the ejection modules 200 are mounted, whereas FIG. 7F illustrates a surface of the third channel member 70 in contact with the liquid ejection unit support portion 81. The first channel member 50 and the second channel member 60 are joined so that the contact surfaces of these channel members 50 and 60, that is, the surfaces illustrated in FIGS. 7B and 7C face each other. The second channel member 60 and the third channel member 70 are joined so that the contact surfaces of these channel members 60 and 70, that is, the surfaces presented in FIGS. 7D and 7E face each other. With the second channel member 60 and the third channel member 70 joined, common channel grooves 62 formed in the second channel member 60 and common channel grooves 71 formed in the third channel member 70 form eight common channels extending in a longitudinal direction of the channel members. Thus, as illustrated in FIGS. 7A to 7F, a set of the common supply channel 211 and the common collection channel 212 is formed for each color inside the channel member 210. Communication holes 72 of the third channel member 70 communicate with respective holes of the joint rubbers 100 and fluidly communicate with the liquid supply units 220. Multiple communication holes 61 are formed in bottom surfaces of the common channel grooves 62 of the second channel member 60 and communicate with one ends of dedicated channel grooves 52 of the first channel member 50. Communication holes 51 are formed at the other ends of the dedicated channel grooves 52 in the first channel member 50 and the dedicated channel grooves 52 fluidly communicate with the multiple ejection modules 200 via the communication holes 51. Through these dedicated channel grooves 52, the channels can be gathered toward the center side of the channel member 210.

The first to third channel members are preferably made of a material that has corrosion resistance to liquid and a low linear expansion coefficient. As an example of a material, a composite material (resin material) may be favorably used in which alumina, liquid crystal polymer (LCP), polyphenyl sulfide (PPS), or polysulfone (PSF) is used as a base material and inorganic fillers such as silica microparticles or fibers are added. As a method of forming the channel member 210, the three channel members may be stacked and bonded together. In a case where a resin composite material is selected as the material, a joining method by welding may be used.

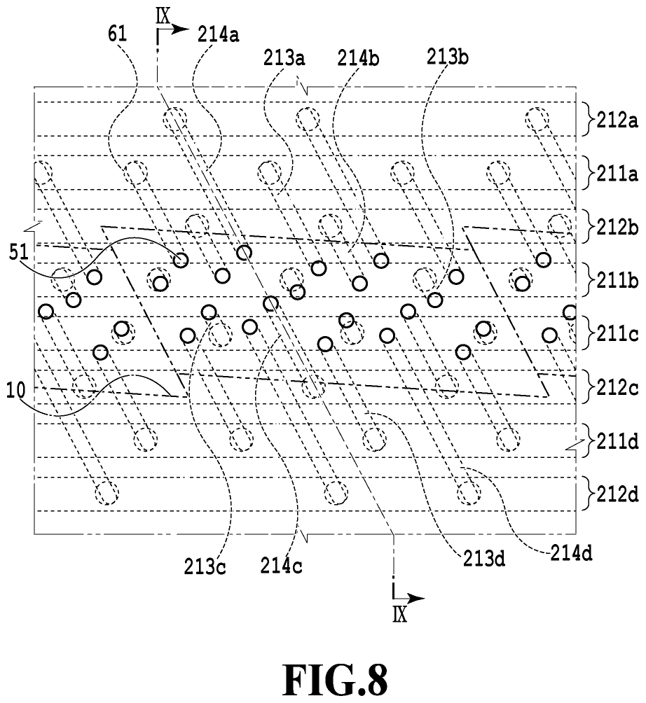

FIG. 8 is an enlarged see-through view illustrating a portion of the channels in the channel member 210 formed by joining the first to third channel members, seen from the surface of the first channel member 50 on which the ejection modules 200 are mounted. Hereinafter, a connection relationship among the channels in the channel member 210 is described. In the channel member 210, for each color, the common supply channel 211 (211a, 211b, 211c, or 211d) and the common collection channel 212 (212a, 212b, 212c, or 212d) are provided which extend in the longitudinal direction of the liquid ejection head 3. The common supply channel 211 for each color is connected via the communication holes 61 to multiple dedicated supply channels 213 (213a, 213b, 213c, or 213d) formed by the dedicated channel grooves 52. The common collection channel 212 for each color is connected via the communication holes 61 to multiple dedicated collection channels 214 (214a, 214b, 214c, or 214d) formed by the dedicated channel grooves 52. With this channel structure, the inks can be gathered from all the common supply channels 211 via the dedicated supply channels 213 to the print element boards 10 located on the center portion of the channel member 210. In addition, the inks can be collected from the print element boards 10 via the dedicated collection channels 214 to all the common collection channels 212.

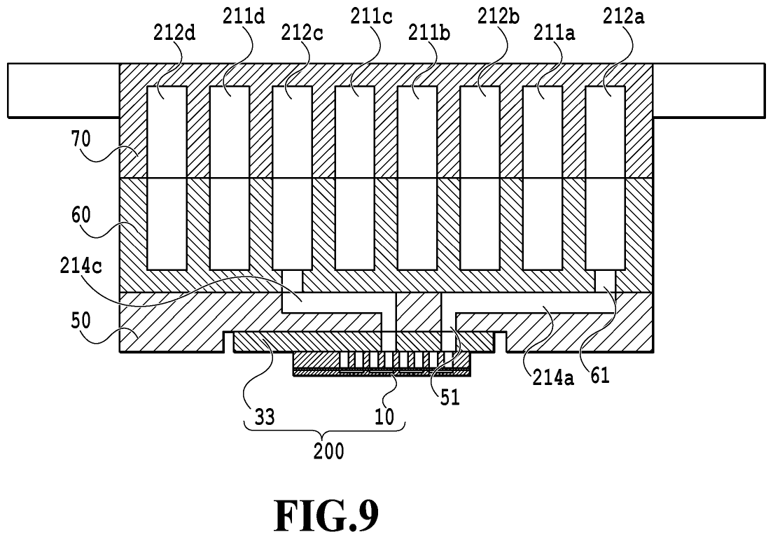

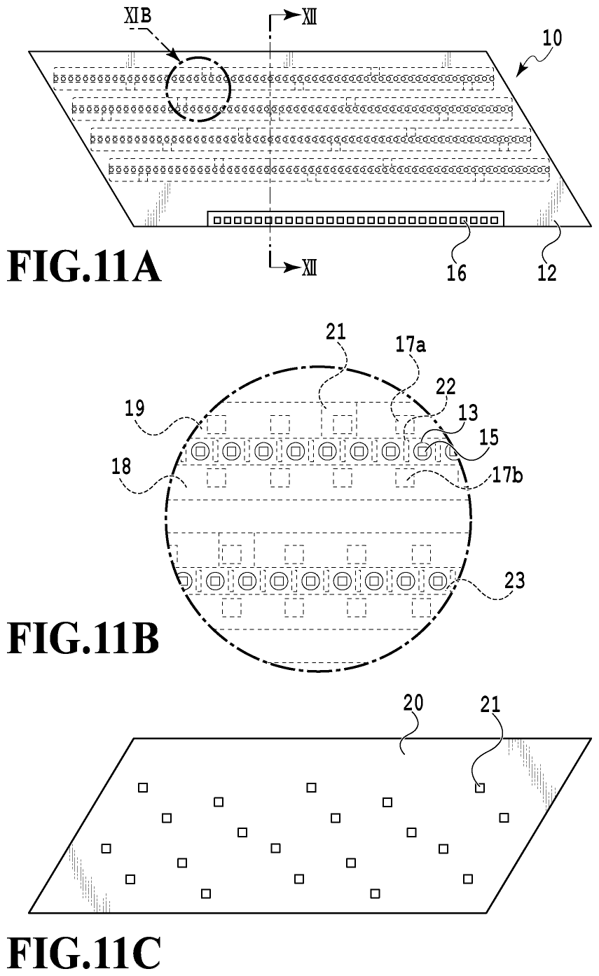

FIG. 9 is a view illustrating a cross section taken along a line IX-IX in FIG. 8. As illustrated in FIG. 9, the dedicated collection channels (214a and 214c) communicate with the ejection module 200 via the communication holes 51. Although FIG. 9 only illustrates the dedicated collection channels (214a and 214c), the dedicated supply channels 213 communicate with the ejection module 200 in another cross section as illustrated in FIG. 8. In a support member 33 and the print element board 10 included in each ejection module 200, channels are formed to supply the inks from the first channel member 50 to print elements 15 (see FIG. 11B) provided to the print element board 10. In the support member 33 and the print element board 10, channels are also formed to return (circulate) portions or all of the inks supplied to the print elements 15 to the first channel member 50. Here, the common supply channel 211 for each color is connected to the negative pressure control unit 230 (high pressure side) for that color via the liquid supply units 220, while the common collection channel 212 is connected to the negative pressure control unit 230 (low pressure side) via the liquid supply units 220. This negative pressure control unit 230 generates a differential pressure (pressure difference) between the common supply channel 211 and the common collection channel 212. Thus, as illustrated in FIGS. 8 and 9, in the liquid ejection head in which the channels are connected together, a flow for each color is generated such that the ink flows from the common supply channel 211 to the dedicated supply channels 213a, the print element boards 10, the dedicated collection channels 214b, and the common collection channel 212 in this order.

FIG. 10A is a perspective view illustrating one ejection module 200 and FIG. 10B is an exploded view of the ejection module 200. As a method of producing the ejection module 200, first the print element board 10 and the flexible wiring board 40 are bonded onto the support member 33 in which liquid communication holes 37 are formed in advance. After that, terminals 16 on the print element board 10 and terminals 41 on the flexible wiring board 40 are electrically connected to each other by wire bonding, and then the wire bonding portion (electric connection portion) is covered and sealed with the seal member 110. Terminals 42 on the flexible wiring board 40 on the side opposite to the print element board 10 are electrically connected to connection terminals 93 (see FIG. 6) of the electric wiring board 90. The support member 33 is a supporting body that supports the print element board 10 and also functions as a channel member through which the print element board 10 and the channel member 210 fluidly communicate with each other. For this purpose, the support member 33 preferably has a high degree of flatness and can be joined to the print element board 10 with sufficiently high reliability. A material for the support member 33 is preferably, for example, alumina or resin material.

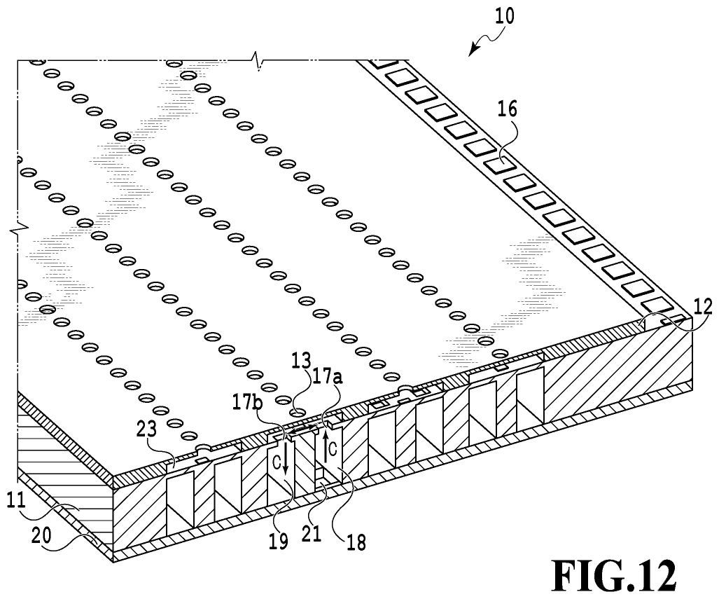

FIG. 11A is a plan view of the surface of the print element board 10 in which the ejection orifices 13 are formed, FIG. 11B is an enlarged view of a portion XIb in FIG. 11A, and FIG. 11C is a plan view of the back side in FIG. 11A. FIG. 12 is a perspective view illustrating a cross section of the print element board 10 and a lid member 20 taken along a cross-section line XII-XII in FIG. 11A. Hereinafter, a structure of the print element board 10 is described.

As illustrated in FIG. 11A, four ejection orifice arrays for the respective colors of inks are formed in an ejection orifice forming member 12 of the print element board 10. Hereinafter, an extension direction of the ejection orifice array in which multiple ejection orifices 13 are arrayed is referred to as an “ejection orifice array direction”.

As illustrated in FIG. 11B, the print element 15 is arranged at a position corresponding to each ejection orifice 13. The print element 15 is a heating element to cause the ink to bubble with thermal energy. A pressure chamber 23 in which the print element 15 is provided is defined by partition walls 22. The print element 15 is electrically connected to the terminal 16 in FIG. 11A via electric wiring (not illustrated) provided to the print element board 10. The print element 15 boils the ink by generating heat based on a pulse signal inputted via the electric wiring board 90 (FIG. 5A) and the flexible wiring board 40 (see FIG. 10B). The force of a bubble generated by this boiling causes the ink to be ejected from the ejection orifice 13. As illustrated in FIG. 12B, along each ejection orifice array, a liquid supply channel 18 extends on one side and a liquid collection channel 19 extends on the other side. The liquid supply channel 18 and the liquid collection channel 19 are channels provided in the print element board 10 and extended in the ejection orifice array direction and communicate with each ejection orifice 13 through a supply port 17a and a collection port 17b, respectively.

As illustrated in FIGS. 11B and 12, the sheet-shaped lid member 20 is laminated on the back surface of the print element board 10 opposite to the surface in which the ejection orifices 13 are formed. In the lid member 20, multiple openings 21 are formed which communicate with the liquid supply channels 18 and the liquid collection paths 19 to be described later. Three openings 21 are provided for one liquid supply channel 18 and two openings 21 are provided for one liquid collection channel 19. As illustrated in FIG. 11C, the openings 21 in the lid member 20 communicate with the multiple communication holes 51 illustrated in FIG. 8 and so on. As illustrated in FIG. 12, the lid member 20 has a function as a lid that forms parts of the walls of the liquid supply channel 18 and the liquid collection channel 19 formed in a substrate 11 in the print element board 10. The lid member 20 preferably has sufficient corrosion resistance to the inks, and the opening shapes and opening positions of the openings 21 are required to achieve high precision from the standpoint of preventing color mixing. For this purpose, it is preferable to use, as a material for the lid member 20, a photosensitive resin material or silicon plate and provide the openings 21 by a photolithography process. Thus, the lid member 20 serves to convert the pitches of the channels by using the openings 21, and therefore it is desirable that the lid member 20 preferably have a small thickness with a pressure drop taken into consideration and be formed of, for example, a film-shaped member.

Next, flows of the inks inside the print element board 10 are described. As illustrated in FIG. 12, in the print element board 10, the substrate 11 formed of Si and the ejection orifice forming member 12 formed of a photosensitive resin are stacked and the lid member 20 is joined to the back surface of the substrate 11. The print elements 15 are formed on one surface side of the substrate 11 (see FIG. 11B), and grooves that form the liquid supply channels 18 and the liquid collection channels 19 extending along the ejection orifice arrays are formed on the back surface side of the substrate 11. The liquid supply channel 18 and the liquid collection channel 19 formed by the substrate 11 and the lid member 20 are connected to the common supply channel 211 and the common collection channel 212 in the channel member 210, respectively, so that a differential pressure is generated between the liquid supply channel 18 and the liquid collection channel 19.

In each ejection orifice 13 not engaged in the ejection operation during printing with the inks ejected from the multiple ejection orifices 13 of the liquid ejection head 3, the ink in the liquid supply channel 18 provided in the substrate 11 flows along arrows C in FIG. 12 due to the above differential pressure. Specifically, the ink flows via the supply port 17a, the pressure chamber 23, and the collection port 17b to the liquid collection channel 19. Through this flow, for example, from the ejection orifice 13 and the pressure chamber 23 not engaged in the printing operation, the thickened ink generated by evaporation through the ejection orifice 13, bubbles, foreign matters, and so on can be collected to the liquid collection channel 19. In addition, this flow can suppress thickening of the ink in the ejection orifice 13 and the pressure chamber 23. The ink collected to the liquid collection channel 19 flows through the openings 21 of the lid member 20 and the liquid communication holes 37 (see FIG. 10B) of the support member 33 and is collected to the communication holes 51, the dedicated collection channels 214, and the common collection channel 212 in the channel member 210 in this order. This ink is eventually collected to the supply path of the printing apparatus 1000.

In sum, the inks supplied from the printing apparatus main body to the liquid ejection head 3 are supplied and collected by flowing in the following order. The inks first flow from the liquid connection portions 111 of the liquid supply units 220 to the inside of the liquid ejection head 3. Then, the inks are supplied to the joint rubbers 100, the communication holes 72 and the common channel grooves 71 provided in the third channel member 70, the common channel grooves 62 and the communication holes 61 provided in the second channel member 60, the dedicated channel grooves 52 and the communication holes 51 provided in the first channel member 50 in this order. After that, the inks are supplied to the pressure chambers 23 via the liquid communication holes 37 provided in the support member 33, the openings 21 provided in the lid member 20, and the liquid supply channels 18 and the supply ports 17a provided in the substrate 11. Of the inks supplied to the pressure chambers 23, the inks not ejected from the ejection orifices 13 flow through the collection ports 17b and the liquid collection channels 19 provided in the substrate 11, the openings 21 provided in the lid member 20, and the liquid communication holes 37 provided in the support member 33 in this order. Thereafter, the inks flow through the communication holes 51 and the dedicated channel grooves 52 in the first channel member 50, the communication holes 61 and the common channel grooves 62 provided in the second channel member 60, the common channel grooves 71 and the communication holes 72 provided in the third channel member 70, and the joint rubbers 100 in this order. Moreover, the inks flow out to the outside of the liquid ejection head 3 from the liquid connection portions 111 provided in the liquid supply units 220. In the mode of the first circulation path illustrated in FIG. 3, the inks flowing in from the liquid connection portions 111 are supplied to the joint rubbers 100 after passing through the negative pressure control units 230. In the mode of the second circulation path illustrated in FIG. 4, the inks collected from the pressure chambers 23 pass through the joint rubbers 100 and then flow to the outside of the liquid ejection head 3 from the liquid connection portions 111 via the negative pressure control units 230.

In addition, as illustrated in FIGS. 3 and 4, not all of the ink flowing from the one end of each common supply channel 211 in the liquid ejection unit 300 is supplied to the pressure chambers 23 via the dedicated supply channels 213a. A portion of the ink flows out from the other end of the common supply channel 211 to the liquid supply unit 220 without entering the dedicated supply channels 213a. In the case where a path through which the ink flows without entering the print element boards 10 is provided as described above, it is possible to suppress a backflow of the circulating flow of the ink even if the liquid ejection head 3 is provided with the print element boards 10 including fine channels with high flow resistance. Therefore, the liquid ejection head 3 can suppress thickening of the ink in the vicinity of the pressure chambers and the ejection orifices, thereby suppressing a deviation of an ejection direction from a proper direction and non-ejection, which results in achievement of high-quality printing.

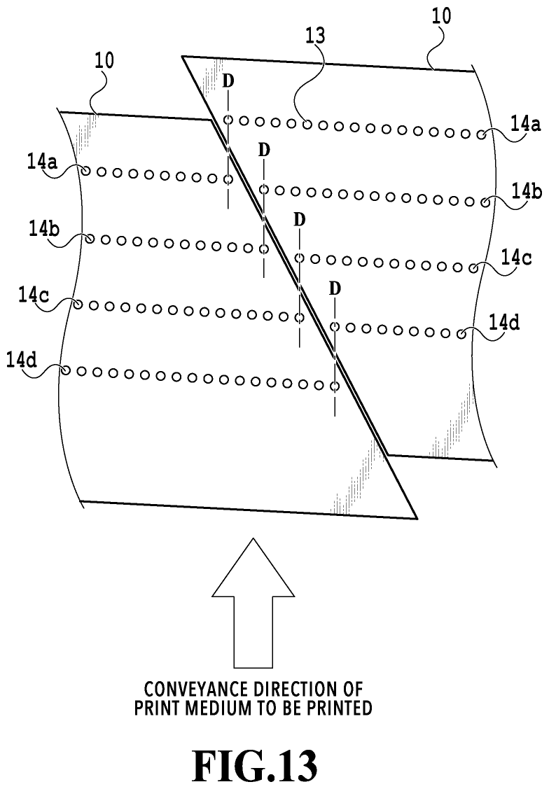

FIG. 13 is an enlarged plan view partially illustrating adjacent portions of the print element boards 10 in the two adjacent ejection modules. As illustrated in FIG. 11A and others, the print element boards 10 in a substantially parallelogram shape are used. As illustrated in FIG. 13, each of the ejection orifice arrays (14a to 14d) in which the ejection orifices 13 are arrayed in each print element board 10 is inclined at a predetermined angle with respect to the print medium conveyance direction. As a result, at least one ejection orifice in each ejection orifice array in one of the adjacent portions of the print element boards 10 overlaps at least one ejection orifice in the corresponding ejection orifice array in the other adjacent portion in the print medium conveyance direction. In FIG. 13, two ejection orifices on each D line overlap each other. With this arrangement, even if the positions of the print element boards 10 are slightly misaligned from predetermined positions, black streaks or white spots that may appear in a printed image can be made less visually-noticeable by driving control of the overlapping ejection orifices. Also in the case where the multiple print element boards 10 are arranged in a linear pattern (in-line) instead of the staggered pattern, a structure as in FIG. 13 may be obtained. This structure makes it possible to prevent black streaks or white spots at the joint area between the print element boards 10 while suppressing an increase in the length of the liquid ejection head 3 in the print medium conveyance direction. Here, the principle planes of the print element boards 10 are each formed in a substantially parallelogram shape, but their shape is not limited to this. For example, even in a case where print element boards in a rectangular, trapezoidal or other shape are used, the present disclosure can be preferably applied.

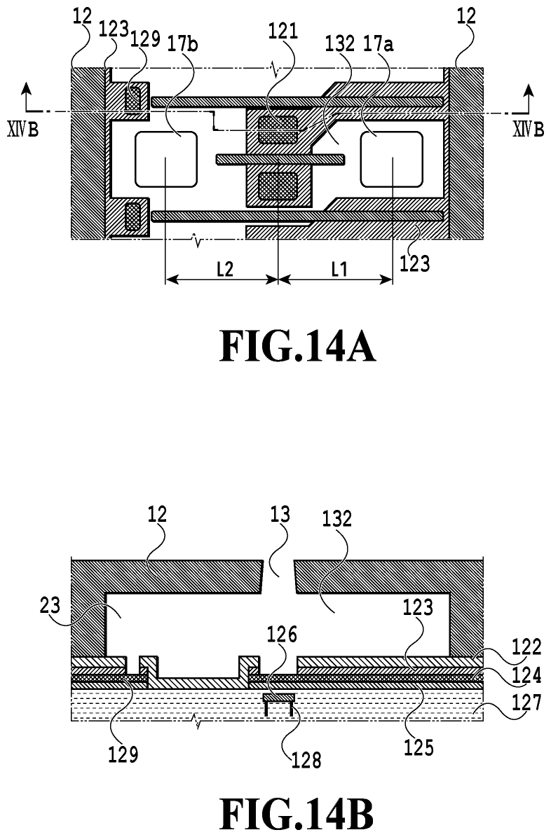

FIG. 14A is an enlarged plan view schematically illustrating an area near a heating portion of the print element board 10, and FIG. 14B is a cross-sectional view taken along a dash-dot line XIVb-XIVb in FIG. 14A. Hereinafter, a structure of the heating portion in the print element board according to the present embodiment is described.

In the liquid ejection head 3, a substrate for liquid ejection printing is formed by stacking multiple layers on a base substrate (not illustrated) made of silicon. In the present embodiment, a thermal storage layer (not illustrated) formed of a thermal oxide film, a SiO film, a SiN film, or the like is disposed on the base substrate. Then, a heating resistor 126 is disposed on the thermal storage layer and is connected via a tungsten plug 128 to an electrode wiring layer (not illustrated, formed in an underlying layer of an insulating protective layer 127 in FIG. 14B) as wiring formed of a metal material such as Al, Al-Si, or Al-Cu. The heating resistor 126 generates heat with power supplied via the electrode wiring layer not illustrated.

As illustrated in FIG. 14B, the heating resistor 126 is covered with the insulating protective layer 127. The insulating protective layer 127 is an insulating layer provided also on top of the heating resistor 126 so as to cover the heating resistor 126. The insulating protective layer 127 is formed of a SiO film, a SiN film, or the like.

Three protective layers for insulating the insulating protective layer 127 from contact with the liquid are formed on the insulating protective layer 127. The three protective layers include a lower protective layer 125, an upper protective layer 124, and an adhesive protective layer 123, and protects the surface of the heating resistor 126 from chemical and physical shocks associated with heat generation of the heating resistor 126.

In the present embodiment, the lower protective layer 125 is formed of tantalum (Ta), the upper protective layer 124 is formed of iridium (Ir), and the adhesive protective layer 123 is formed of tantalum (Ta). The protective layers formed of these materials are electrically conductive. An adhesive protective layer 122 for improving the liquid resistance and the adhesion to the ejection orifice forming member 12 is provided on the adhesive protective layer 123. The adhesive protective layer 122 is formed of SiC. At a position opposed to the heating resistor 126, the adhesive protective layer 122 is not disposed, and the upper protective layer 124 is exposed to the inside of the pressure chamber 23 and functions as a portion for protecting the heating resistor 126. This area functions as a heating portion during the ejection operation. The upper protective layer 124 is formed of a material containing a metal that is dissolvable through an electrochemical reaction and that will not form a dissolution-preventive oxide film under heating.

The upper protective layer 124 in the heating portion is in contact with the liquid. In ejection of the liquid, the liquid instantaneously rises in temperature to cause cavitation in which a bubble is generated and collapsed. For this reason, in the present embodiment, the upper protective layer 124 formed of an iridium material having high corrosion resistance and high reliability is arranged at the position in contact with the liquid.

In the present embodiment, the pressure chamber 23 employs an ink circulation structure in which the liquid is supplied from the supply port 17a and is collected to the collection port 17b. Accordingly, during printing, the liquid flows on the heating resistor 126 in the direction from the supply port 17a on the upstream side to the collection port 17b on the downstream side.

In the case of the method of ejecting the ink with heating by the heating resistor 126, the ink heated by the heating resistor 126 may cause kogation of the ink to adhere to the surface of the upper protective layer 124, which resultantly changes the ejection velocity.

To prevent this, an electrode (electrode portion) 129 capable of electrically connecting with the upper protective layer 124 (protective portion) in the heating portion via the ink is formed in the pressure chamber 23. Then, a voltage is applied between the electrode 129 and the upper protective layer 124, and an electric connection via the ink is established between them, so that the upper protective layer 124 formed of iridium is dissolved into the ink (the liquid). With this dissolution, kogation accumulated on the upper protective layer 124 is removed. More specifically, a portion of the upper protective layer 124 right above the heating resistor 126 is used as an electrode (anode) 121 and the electrode 129 is used as a counter electrode (cathode). With these electrodes, an electrochemical reaction (metal dissolution reaction) is caused to dissolve the metal in the upper protective layer 124 into the ink. Through such dissolution of the metal in the upper protective layer 124 into the ink, the kogation accumulated on the upper protective layer 124 is removed together with the dissolved metal.

Here, the portion of the upper protective layer 124 right above the heating resistor 126 (in an ink ejection direction viewed from the heating resistor 126) is used as the electrode 121, whereas ground wiring (not illustrated) or an electrode opposed to the electrode 121 may be provided as the other electrode 129.

The removal of kogation accumulated on the upper protective layer 124 as described above (hereinafter referred to as a kogation removal operation) can turn the surface layer of the heating portion into a state having no kogation or only little kogation. In the prior art, the kogation removal operation is performed at the fixed timing when the number of drive pulses applied to the multiple heating resistors 126 arrayed in the liquid ejection head 3 reaches a predetermined value (for example, 5×10⁸ ) or above.

However, a degree of kogation adhesion varies among different types of inks and depending on changes in ink physical properties due to distribution of ink cartridges. For this reason, in the case where the kogation removal operation is scheduled to be executed at the fixed timing with a predetermined number of drive pulses set as a threshold, the kogation removal operation may be executed in a situation where kogation adhesion is not heavy enough to affect the ejection characteristics. In the case where the kogation removal operation is executed before kogation adhesion starts affecting the ejection characteristics as described above, the lifespans of the heating resistors may be shortened.

To address this, in the present embodiment, the timing to execute the kogation removal operation is determined depending on an ink type, an ink distribution duration, an installation duration of an ink cartridge 1006 in an installation unit of the printing apparatus 1000, and the number of drive pulses applied to an electrothermal transducer element concerned.

It is preferable to perform kogation removal at the timing when the ejection characteristics such as the ejection velocity change enough to affect an image. For example, it is known that as the ejection velocity is slowed down by 2 m/s, image deterioration such as uneven density and misaligned lines is observed. Meanwhile, it is also known that the number of drives required to slow down the ejection velocity by 2 m/s varies depending on conditions such as the ink type and distribution duration and the installation duration. For this reason, in the present embodiment, the number of drive pulses required to slow down the ejection velocity by 2 m/s from a kogation-free state is obtained in advance under each of various sets of conditions in experiments, and is stored as a threshold in association with the relevant set of conditions. Then, the kogation removal operation is executed at the timing when the total number of drive pulses after the start of use of the liquid ejection head or the previous execution of the kogation removal operation exceeds this threshold.

Here, the slowdown of the velocity is not limited to 2 m/s, and is desirably set to an appropriate value depending on an apparatus.

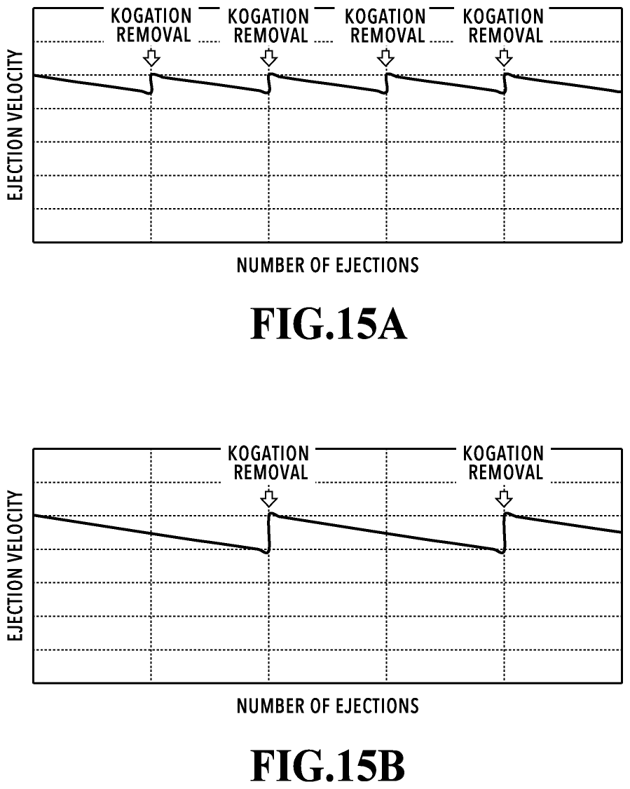

For example, here, consider an ink that requires about twice the number of drives to slow down the ejection velocity by 2 m/s compared to other inks. FIG. 15A is a graph presenting a relationship between the ejection velocity and the number of ejections (the number of drive pulses) of the ink in the case where the kogation removal operation is executed at the fixed timing when the number of drive pulses reaches a predetermined threshold (for example 5×10⁸) or above in the prior art. FIG. 15B is a graph presenting a relationship between the ejection velocity and the number of ejections of the ink in the case where the kogation removal operation is performed depending on the ink type and distribution duration and the installation duration in the present embodiment.

As presented in FIG. 15B, depending on the ink type and distribution duration, the number of drive pulses until the next kogation removal operation (for example, 10×10⁸=1.0×10⁹) is larger than the predetermined number of drive pulses (for example, 5×10⁸) and the interval until the execution of the kogation removal operation is longer than in the prior art. In other words, it is possible to avoid executing the kogation removal operation more than necessary in a situation where the ejection characteristics do not change significantly. As a result, the lifespan of the liquid ejection head can be made longer than in the prior art.

In contrast, in the case of an ink that requires about half of the number of drives to slow down the ejection velocity by 2 m/s compared to other inks, the number of drive pulses until the next kogation removal operation (for example, 2.5×10⁸) is smaller than the predetermined number of drive pulses (for example, 5×10⁸). Accordingly, the interval until the execution of the kogation removal operation is shorter than in the prior art. In other words, it is possible to execute the kogation removal operation at appropriate timing when the ejection characteristics change. As a result, deterioration of image quality can be prevented.

Here, it is desirable that the number of drive pulses of the electrothermal transducer element set as the threshold be within a range of 5×10⁸ to 6×10⁹.

In FIGS. 5A to 13, the description is given of the mode in which one liquid ejection head 3 ejects the four colors of inks for convenience. Instead, in the following present embodiment, a mode is described in which one liquid ejection head 3 ejects only one color of ink (one type of ink). In addition, on a liquid ejection apparatus, the same number of liquid ejection heads 3 as that of ink colors to be used and ink cartridges 1006 which store inks supplied to the respective liquid ejection heads 3 are mounted in a detachable manner.

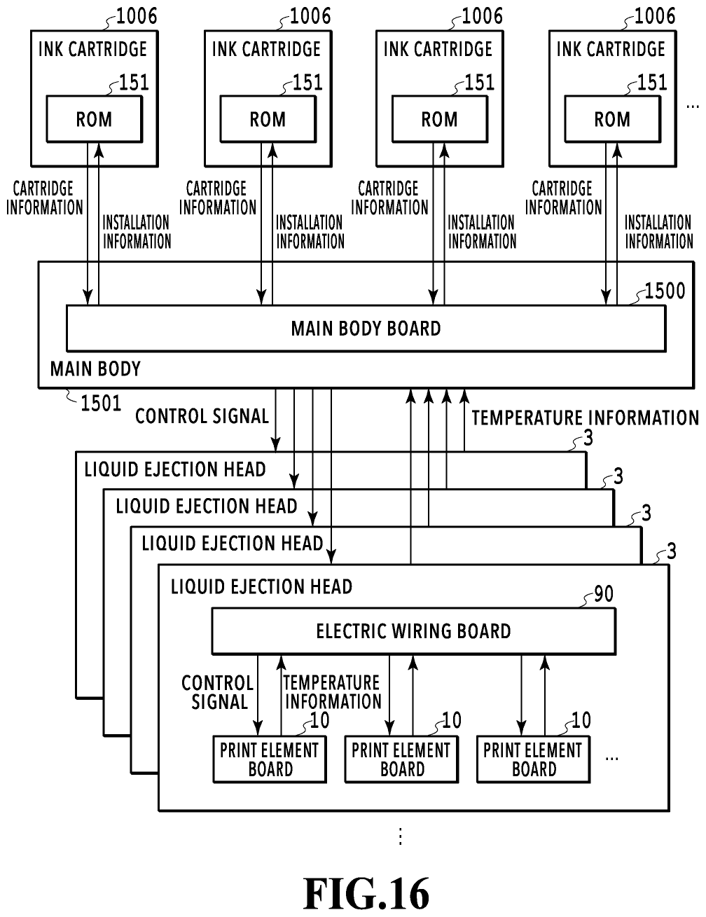

FIG. 16 is a diagram illustrating a model of communication between the liquid ejection heads 3, the main body of the printing apparatus 1000, and the ink cartridges 1006. A main body board 1500 provided in the main body of the printing apparatus 1000 includes the CPU 30a, the ROM 30c, the RAM 30b, and so on (see FIG. 2). From a ROM 151 of each of the ink cartridges 1006, the CPU 30a in the main body board 1500 receives information about the ink cartridge 1006 such as a manufacture date and time, an ink type, an amount of filled ink, and an installation duration in the main body. In reference to a table or the like stored in advance in the ROM 30c of the main body board 1500, the CPU 30a transmits, to the electric wiring board 90 of each of the liquid ejection heads 3, the threshold associated with the above set of conditions as information on an ejection characteristic of the relevant ink cartridge 1006. The CPU 30a writes the installation duration of the ink cartridge 1006 in the main body to the ROM 30c.

Moreover, the CPU 30a of the main body board 1500 receives temperature information of each of the print element boards 10 from the liquid ejection head 3 and transmits a control signal for driving the print element board 10 based on the received temperature information to the electric wiring board 90 of the liquid ejection head 3.

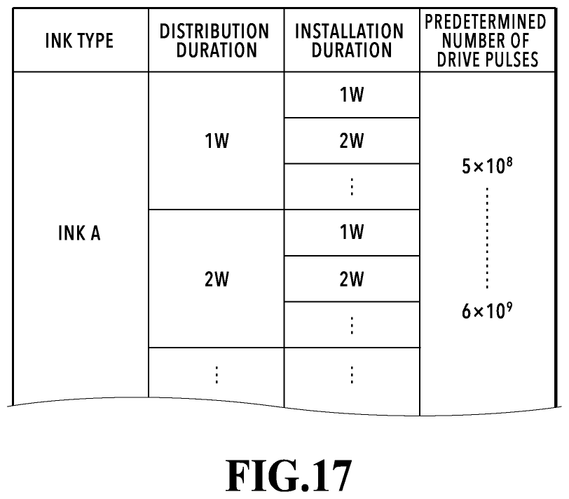

FIG. 17 is a diagram presenting an example of a table to which the CPU 30a refers in order to determine whether or not to execute the kogation removal operation. In the table, the following information items about the ink cartridge 1006 are associated with each other: the ink type, the distribution duration (current date-manufacture date (dd/mm/yyyy)), the installation duration in the main body, and a suitable number of drive pulses for execution of the kogation removal operation after the previous kogation removal operation. Based on this table, the CPU 30a determines the timing to execute the kogation removal operation on the liquid ejection head 3 that ejects the ink supplied from the installed ink cartridge 1006. The example in FIG. 17 employs the mode in which the number of drive pulses is set based on the three conditions, namely, the ink type, the distribution duration, and the installation duration. Instead, the table may employ a mode in which the number of drive pulses is set based on at least one condition. For example, the threshold for the number of drive pulses may be associated with an ink type on a one-to-one basis. Instead, the threshold for the number of drive pulses may be associated with the sum of the distribution duration and the installation duration on a one-to-one basis. In FIG. 17, “W”written in the table denotes “week(s)”.

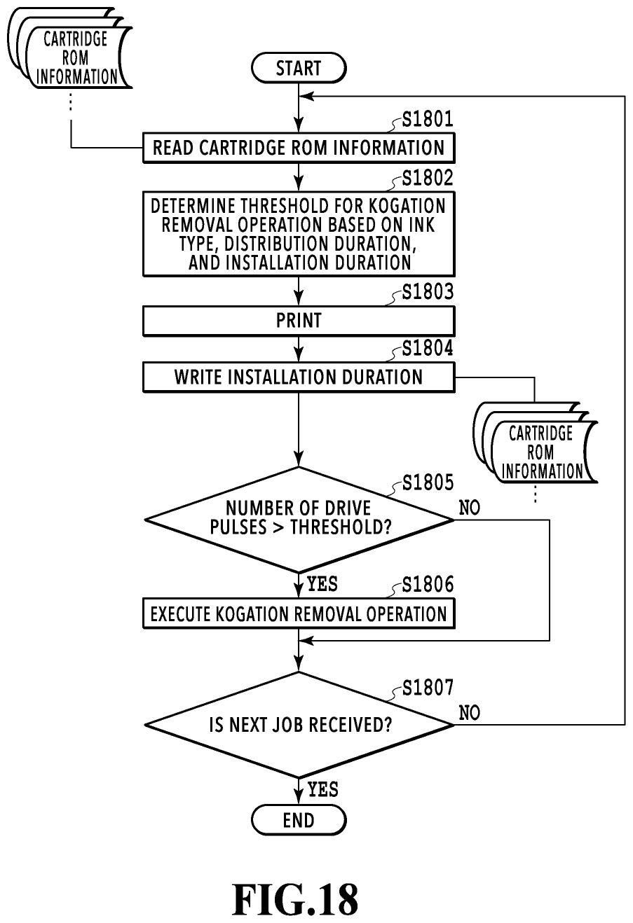

FIG. 18 is a flowchart presenting a sequence example of a series of a printing process and a kogation removal process. The series of processes presented in FIG. 18 is performed by the CPU 30a in the printing apparatus 1000 loading program codes stored in a program memory into a data memory and executing the loaded program codes. Instead, some or all of functions in steps of FIG. 18 may be implemented by hardware such as an ASIC or electronic circuit. In description of each process, sign “S” indicates a step in this flowchart. Hereinafter, the printing process and the kogation removal process in the present embodiment are described by using the flowchart in FIG. 18.

Upon input of a print job, the CPU 30a reads cartridge information from the ROM 151 of each ink cartridge 1006 in S1801. The cartridge information contains a cartridge No., an ink type, a manufacture date (dd/mm/yyyy), an amount of filled ink, and an installation duration in the main body. In S1802, the CPU 30a refers to the table stored in the ROM 30c and determines the threshold (predetermined threshold) for the number of drive pulses based on the information read in S1801. For example, assume that the ink type contained in a target ink cartridge 1006 is “ink A”, the distribution duration of the cartridge is “2 W”, and the installation duration of the cartridge is “1 W”. In this case, the CPU 30a sets “6×10⁹” as the threshold to be applied to the liquid ejection head 3 associated with the ink cartridge.

In S1803, the CPU 30a performs the printing process according to the inputted print job. After completion of the printing process, in S1804, the CPU 30a writes the installation duration of the ink cartridge 1006 stored in the ROM 30c in the printing apparatus 1000 into the ROM 151 of the ink cartridge 1006. In other words, the installation duration in the main body stored in the ROM 151 of the ink cartridge 1006 is updated.

After that, in S1805, the CPU 30a determines whether or not the number of drive pulses exceeds the threshold determined in S1802. The CPU 30a advances to S1806 if the number exceeds the threshold (Yes) or advances to S 1807 if not (No). If advancing to S1806, the CPU 30a executes the kogation removal operation (kogation removal) by dissolving the upper protective layer 124 into the ink through an electrochemical reaction. If advancing to S1807, the CPU 30a determines whether or not the next job is received. If the next job is received (Yes), the CPU 30a returns to S1801 and iterates the processes. If the next job is not received (No), the present series of processes is ended.

In this way, the kogation removal operation of dissolving the metal in the protective layer through an electrochemical reaction with the ink is executed based on the information on the ejection characteristic of the ink. Accordingly, it is possible to execute the kogation removal operation at appropriate timing, which makes it possible for a liquid ejection head to stably eject a liquid without shortening the lifespan of the liquid ejection head.

The present embodiment is described by using, as an example, the printing apparatus 1000 in which the inks are circulated through the liquid ejection heads 3. However, the present disclosure is not limited to this, and may be applied to a printing apparatus in which inks are not circulated. In addition, the present embodiment is described by using the line-type liquid ejection head as an example. However, the present disclosure is not limited to this, and may be applied to a serial-type liquid ejection head configured to perform printing by alternately moving a liquid ejection head and a print medium relative to each other.

### Second Embodiment

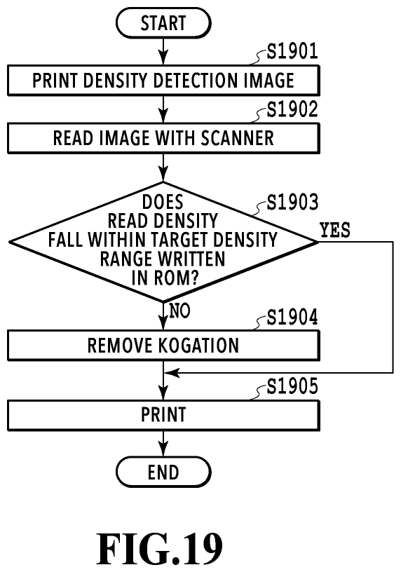

Hereinafter, a second embodiment of the present disclosure is described with reference to FIG. 19. Since the basic structure of the present embodiment is the same as that of the first embodiment, a characteristic structure is described below.

In the present embodiment, a test image for density detection is printed, the printed image is read by a scanner, and the kogation removal process is executed based on whether or not the density of the read image falls within a preset target density range.

In the case where the ejection velocity slows down due to the occurrence of kogation on the upper protective layer 124, the ejection velocity varies between the ejection orifice opposed to the upper protective layer 124 with the occurrence of kogation and the ejection orifice opposed to the upper protective layer 124 without the occurrence of kogation. For this reason, even in a case where an image with uniform density is printed, uneven density occurs in the image. Whether or not to execute the kogation removal process is determined depending on whether or not this uneven density in the image falls within the preset target density range.

FIG. 19 is a flowchart presenting printing processing in the present embodiment. A series of processes presented in FIG. 19 is performed by the CPU 30a in the printing apparatus 1000 loading program codes stored in the program memory into the data memory and executing the loaded program codes. Instead, some or all of functions in steps of FIG. 19 may be implemented by hardware such as an ASIC or electronic circuit. In description of each process, sign “S” indicates a step in this flowchart. Hereinafter, a printing process and a kogation removal process in the present embodiment are described by using the flowchart in FIG. 19.

Upon input of a print job, the CPU 30a prints a test image with uniform density in S1901. In S1902, the CPU 30a reads the printed image with uniform density with a scanner, which is an optical sensor. After that, in S1903, the CPU 30a determines whether or not the density of the read image (information on an ejection characteristic) falls within the preset target density range. The CPU 30a advances to S1905 if the density falls within the preset target density range or advances to S1904 if not. If advancing to S1904, the CPU 30a executes the kogation removal operation (kogation removal) by dissolving the upper protective layer 124 into the ink through an electrochemical reaction. If advancing to S1905, the CPU 30a performs the printing process according to the print job and then ends the present processing.

In this way, according to the present embodiment, the kogation removal operation is executed based on the information on the ejection characteristic, specifically, the density of a read image. Accordingly, it is possible to execute the kogation removal operation at appropriate timing, which makes it possible for a liquid ejection head to stably eject a liquid without shortening the lifespan of the liquid ejection head.

### Third Embodiment

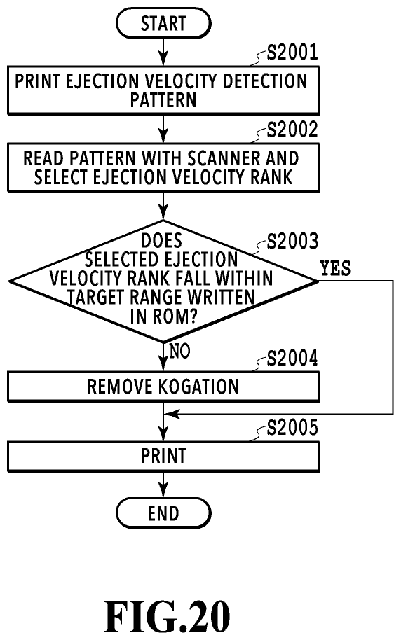

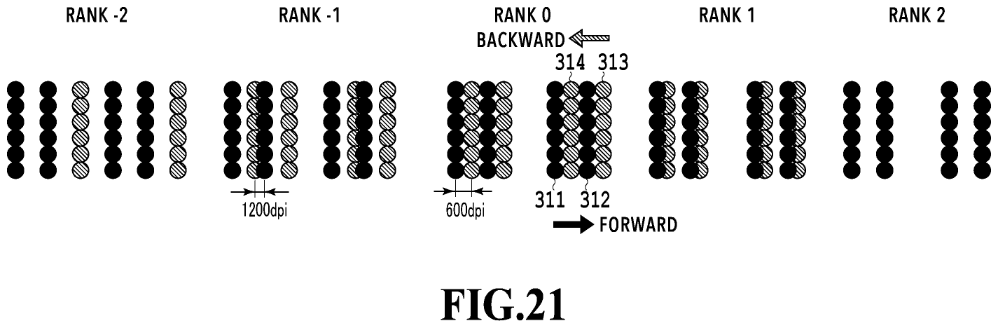

Hereinafter, a third embodiment of the present disclosure is described with reference to FIGS. 20 and 21. Since the basic structure of the present embodiment is the same as that of the first embodiment, a characteristic structure is described below.

In the present embodiment, an ejection velocity detection pattern is printed, the printed pattern is read by a scanner, which is an optical sensor, and the kogation removal process is executed based on an ejection velocity rank determined based on the read ejection velocity detection pattern.

FIG. 20 is a flowchart presenting printing processing in the present embodiment. A series of processes presented in FIG. 20 is performed by the CPU 30a in the printing apparatus 1000 loading program codes stored in the program memory into the data memory and executing the loaded program codes. Instead, some or all of functions in steps of FIG. 20 may be implemented by hardware such as an ASIC or electronic circuit. In description of each process, sign “S” indicates a step in this flowchart. Hereinafter, a printing process and a kogation removal process in the present embodiment are described by using the flowchart in FIG. 20.

Upon input of a print job, the CPU 30a prints the ejection velocity detection pattern in S2001. In S2002, the CPU 30a reads the printed ejection velocity detection pattern with a scanner and selects an ejection velocity rank. After that, in S2003, the CPU 30a determines whether or not the selected ejection velocity rank (information on an ejection characteristic) falls within a preset target range. The CPU 30a advances to S2005 if the selected rank falls within the preset target range or advances to S2004 if the selected rank does not fall within the preset target range. If advancing to S2004, the CPU 30a executes the kogation removal operation (kogation removal) by dissolving the upper protective layer 124 into the ink through an electrochemical reaction. If advancing to S205, the CPU 30a performs the printing process according to the print job and then ends the present processing.

FIG. 21 is a diagram illustrating an example of the ejection velocity detection pattern. In FIG. 21, each black circle represents a dot printed while a print medium is conveyed in a forward direction (forward printing), and each hatched circle represents a dot printed while the print medium is conveyed in a backward direction (backward printing). FIG. 21 illustrates dots printed by six ejection elements for simplification of description. In the case of use of a serial-type liquid ejection head, the same or similar pattern may be printed while the liquid ejection head is reciprocated relative to a print medium.

In printing of the ejection velocity detection pattern, the ejection timing is adjusted such that a first row 311 of dots landed in the forward printing and a second row 312 of dots landed in the forward printing are shifted from each other by one pixel in 300 dpi and a first row 313 of dots landed in the backward printing and a second row 314 of dots landed in the backward printing are shifted from each other by one pixel in 300 dpi and shifted by one pixel of 600 dpi from the first row 311 and the second row 312 in the forward printing, respectively. In the case where no kogation occurs on the heating portions and the ink is ejected at a standard velocity, a dot pattern as illustrated in a rank 0 is obtained. On the other hand, in the case where kogation occurs on the heating portions and the ink is ejected at a velocity lower than the standard velocity, a dot pattern illustrated in a rank 1 is formed. Conversely, in the case where the ink is ejected at a velocity higher than the standard velocity, a dot pattern illustrated in a rank −1 is formed. The ejection velocity detection pattern thus printed is read by the scanner included in the printing apparatus 1000 in S2002 in FIG. 20, and then the ejection velocity rank can be selected based on the read result (the amount of shift between the landing positions in the forward printing and the backward printing).

For example, in the case where the selected rank is within ±1, the CPU 30a determines YES in S2003 and skips the kogation removal operation. On the other hand, in the case where the selected rank falls above or below ±1, the CPU 30a determines NO in S2003 and executes the kogation removal operation.

In this way, the kogation removal operation is executed based on the information on the ejection characteristic, specifically, the ejection velocity rank selected based on the read ejection velocity detection pattern. Accordingly, it is possible to execute the kogation removal operation at appropriate timing, which makes it possible for a liquid ejection head to stably eject the liquid stably without shortening the lifespan of the liquid ejection head.

### Other Embodiments

The above embodiments are described in the mode where the kogation removal operation is executed at the timing with the input of a print job. Instead, irrespective of a print job, a kogation removal determination process may be executed at regular intervals or in response to a user's instruction.

The above embodiments employ the mode where one liquid ejection head 3 ejects one color of ink and the kogation removal operation is executed on each of the liquid ejection heads 3 for the respective colors. However, the present disclosure is not limited to this mode. One liquid ejection head 3 may eject multiple inks. In this case, the kogation removal operation may be executed on each of ejection element arrays for the respective colors. In addition, ink cartridges may be formed integrally with a print head.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-139890, filed Aug. 21, 2024, which is hereby incorporated by reference herein in its entirety.

What is claimed is:

1. A liquid ejection apparatus comprising:
an ejection unit including
a heating resistor configured to generate heat with power supply, thereby generating energy for ejecting a liquid,
a protective portion configured to cover and protect the heating resistor, and
an electrode portion capable of electrically connecting with the protective portion via the liquid; and
a control unit configured to control a kogation removal operation of removing kogation by applying a voltage between the protective portion and the electrode portion, and thereby dissolving the protective portion into the liquid, wherein
based on information on an ejection characteristic of a liquid, the control unit determines timing to execute the kogation removal operation in the ejection unit configured to eject the liquid.

2. The liquid ejection apparatus according to claim 1, wherein the information on the ejection characteristic is a threshold for a total number of drive pulses applied to the heating resistor of the ejection unit after previous execution of the kogation removal operation in the ejection unit.

3. The liquid ejection apparatus according to claim 2, further comprising an installation unit in which a plurality of cartridges configured to supply liquids to a plurality of the ejection units, respectively, are installable, wherein
each of the plurality of cartridges includes a storage unit configured to store information on at least one of a type of the liquid contained, a distribution duration, and an installation duration in the liquid ejection apparatus, and
the control unit sets the threshold for each of the ejection units based on the information read from the corresponding one of the storage units.

4. The liquid ejection apparatus according to claim 2, wherein the threshold is within a range of 5×10⁸ to 6×10⁹.

5. The liquid ejection apparatus according to claim 1, wherein the information on the ejection characteristic is a density of an image formed by ejection with the ejection unit.

6. The liquid ejection apparatus according to claim 5, wherein the control unit executes the kogation removal operation in a case where the density of the image does not fall within a preset target density range.

7. The liquid ejection apparatus according to claim 1, wherein the information on the ejection characteristic is an ejection velocity of the ejection unit.

8. The liquid ejection apparatus according to claim 7, wherein the control unit executes the kogation removal operation in a case where the ejection velocity does not fall within a preset target range.

9. The liquid ejection apparatus according to claim 7, wherein the ejection velocity is obtained based on an amount of shift between landing positions in forward printing and backward printing performed on a print medium by the ejection unit.

10. The liquid ejection apparatus according to claim 1, wherein the protective portion and the electrode portion are formed of the same metal material.

11. The liquid ejection apparatus according to claim 1, wherein the electrode portion functions as a ground in the kogation removal operation.

12. A control method of a liquid ejection apparatus, comprising:
an ejecting step of ejecting a liquid from an ejection unit with an action of a heating resistor;
an obtaining step of obtaining information on an ejection characteristic of the liquid; and
a dissolving step of dissolving a metal in a protective layer through an electrochemical reaction with the liquid, the protective layer provided in a heating portion on which heat generated by the heating resistor acts, wherein
the dissolving step that is a kogation removal operation is executed based on the information on the ejection characteristic of the liquid obtained in the obtaining step.

13. The control method of the liquid ejection apparatus according to claim 12, wherein the information on the ejection characteristic is a threshold for a total number of drive pulses applied to the heating resistor in the ejecting step after previous execution of the kogation removal operation.

14. The control method of the liquid ejection apparatus according to claim 13, further comprising:
an installing step of installing a plurality of cartridges configured to supply liquids to a plurality of the ejection units, respectively; and
a storing step of storing, into a storage unit in each of the plurality of cartridges, information on at least one of a type of the liquid contained, a distribution duration, and an installation duration in the liquid ejection apparatus, wherein
the threshold for each of the ejection units is set based on the information read from the corresponding one of the storage units.

15. The control method of the liquid ejection apparatus according to claim 12, wherein the information on the ejection characteristic is a density of an image formed by ejection in the ejecting step.

16. The control method of the liquid ejection apparatus according to claim 15, wherein the kogation removal operation is executed in a case where the density of the image does not fall within a preset target density range.

17. The control method of the liquid ejection apparatus according to claim 12, wherein the information on the ejection characteristic is an ejection velocity of the ejection unit.

18. The control method of the liquid ejection apparatus according to claim 17, wherein the kogation removal operation is executed in a case where the ejection velocity does not fall within a preset target range.

19. The control method of the liquid ejection apparatus according to claim 17, wherein the ejection velocity is obtained based on an amount of shift between landing positions in forward printing and backward printing performed on a print medium by the ejection unit.
